(19) United States
(12) Patent Application Publication
(10) Pub. No.: US 2006/0208506 A1
(43) Pub. Date: Sep. 21, 2006

(54) Latching mechanism

(75) Inventors: Martin R. Kern, Reutlingen (DE); Richard D. Kuhl, Troy, MI (US); Michael Lawrence, Troy, MI (US); Dennis W. Puskar JR., Algonac, MI (US); Lawrence Vigneau, Ortonville, MI (US)

Correspondence Address: REISING, ETHINGTON, BARNES, KISSELLE, P.C., P O BOX 4390, TROY, MI, 48099-4390, US

(73) Assignee: Sidler Inc., Madison Heights, MI (US)

(21) Appl. No.: 11/071,921

(22) Filed: Mar. 4, 2005

(51) Int. Cl. E05C 19/00

(52) U.S. Cl. 292/304

(57) ABSTRACT

A latching mechanism adapted for use with an assembly within a passenger compartment of the vehicle. The latching mechanism includes an actuator pivotably mounted on the assembly, a biasing device coupled to the actuator, and a dampener coupled to the actuator. The actuator carries an engagement member that is disposed within a detent of a labyrinth when the assembly is closed. The dampener is also coupled to the assembly for retarding movement of the actuator, wherein upon a sudden impact affecting the assembly when closed, the dampener retards movement of the actuator for a predetermined time to enable the engagement member to remain disposed in the detent to keep the assembly closed.

### TECHNICAL FIELD

The present invention generally relates to accessories for vehicle interiors, and more particularly relates to accessories for vehicle interiors having a push-push style latching mechanism.

### BACKGROUND

To open these compartments, push buttons are often provided to allow the operator to release the compartment door. But push buttons on the vehicle interior can be hard to locate, especially when driving or when the vehicle is dimly lit. In addition, push buttons can detract from the aesthetics of the vehicle's interior, especially on instrument panels and glove boxes, because they disrupt the surface continuity of the interior.

In contrast, push-push latches installed on a compartment allow the operator to open or close a compartment door without the use of a handle or button. When the compartment door is in a latched position, the operator merely pushes the door in toward the compartment and releases the door to allow the door to open out and away from the compartment. When the compartment door is open, the operator simply pushes the door towards the compartment to allow the latch to lock and hold the door closed.

Unfortunately, storage compartments equipped with push-push latches tend to open during vehicle jolting in a forward direction or when an object suddenly strikes or impacts the door, such as during a forward vehicle impact. Accordingly, contents of the compartment may fly out, posing further risk of injury during vehicle impact. Thus, current vehicle safety regulations require all compartments to remain closed during an impact. For example, Federal Motor Vehicle Safety Standard (FMVSS) Nos. 201 and 208 require head impact protection for vehicle occupants. Specifically, all latches for interior compartment door assemblies located in the instrument panel, console assemblies, seat backs or side panels must remain latched during an impact.

A latching mechanism has been proposed for preventing opening of a pivotally or laterally mounted door during impact. The latching mechanism is fixed to an inside top surface of a compartment or door frame and engages a fixed striker cam located on a top edge of the pivotally mounted door. The latching mechanism includes an elongated plate mounted on the top inside surface of the compartment and an elongated spring arm is mounted via a rivet on an underside of the elongated plate. The elongated spring arm extends from the rivet along the plate between two longitudinally and laterally spaced apart blocks secured to the underside of the plate. The blocks serve as positioning elements to center the spring arm. The spring arm further extends from the blocks and engages a viscous fluid rotary retardation device, which has a housing secured to the elongated plate with rivets. A rotary member is rotatably mounted to the housing and carries a rotatable arm or plate having opposed projections. The spring arm engages the retardation device between the projections. The spring arm terminates at a point above a notch formed in an upper edge of the door for engaging a striker plate cam secured to a bottom surface of the notch of the compartment door. The elongated spring arm terminates in a turned down portion that contains a cylindrical cam follower element that latches with a depression in the striker cam plate to lock the compartment and hold the door closed. The notch faces towards the interior of the compartment with a solid portion of the door masking the notch from external view.

Unfortunately, the aforementioned latching mechanism has several drawbacks. First, mounting the latching mechanism on the inside of the compartment significantly exposes the working parts to a vehicle occupant. Exposed parts may get bent or broken by objects placed in the compartment or by a child who may play with the parts. Second, the latching mechanism is unnecessarily long and requires an unnecessary amount of vehicle packaging space and, thus, is not suitable for compartments that are shallow in depth.

Accordingly, vehicle interior latches are still not fully optimized for simplicity, packaging, safety, flexibility, and robustness.

### SUMMARY

A presently preferred embodiment of a latching mechanism is provided and adapted for use with an assembly having a first member and a moveable second member. One of the first and second members carries a labyrinth having a detent. The other of the first and second members carries the latching mechanism. The latching mechanism comprises an actuator pivotably mounted on the other of the first and second members. The actuator carries an engagement member that is disposed within the detent of the labyrinth when the assembly is closed. At least one of the actuator and the other of the first and second members includes a first toothed member. The latching mechanism also includes a biasing device coupled to the actuator, and a dampener coupled to the actuator. The dampener includes a second toothed member adapted for engagement with the first toothed member, and is also coupled to the other of the first and second members, wherein upon a sudden impact affecting the assembly when closed, the dampener retards movement of the actuator for a predetermined time to enable the engagement member to remain disposed in the detent to keep the assembly closed.

### BRIEF DESCRIPTION OF THE DRAWINGS

Features and advantages of the present invention will be apparent to those of ordinary skill in the art from the following detailed description of preferred exemplary embodiments and best mode of the invention and the claims, with reference to the accompanying drawings in which:

FIG. 1 is a front view of an assembly having a presently preferred embodiment of a latching mechanism;

FIG. 2 is a rear perspective view of a labyrinth for the latching mechanism of FIG. 1;

FIG. 3 is a side perspective view of another assembly having another presently preferred latching mechanism;

FIG. 4A is a side elevation view of the assembly shown in FIG. 3 in a closed position;

FIG. 4B is a side elevation view of the assembly shown in FIG. 4A in an open position; and

FIG. 5 is a perspective view of another assembly including another presently preferred embodiment of a latching mechanism.

### DETAILED DESCRIPTION

In general, the invention will be described in several illustrative embodiments of an assembly having a latching mechanism for use in a passenger compartment of a vehicle. The invention will be described with reference to its use in automotive vehicles such as cars, trucks, sport-utility vehicles, and the like. However, it will be appreciated as the description proceeds that the invention is useful in many different applications such as recreational vehicles, aircraft, watercraft, and the like, and may be implemented in many other embodiments. In this regard, and as used herein and in the claims, it will be understood that the term “vehicle” refers not only to automotive applications, but also to any other applications wherein the present invention is useful in passenger compartments thereof.

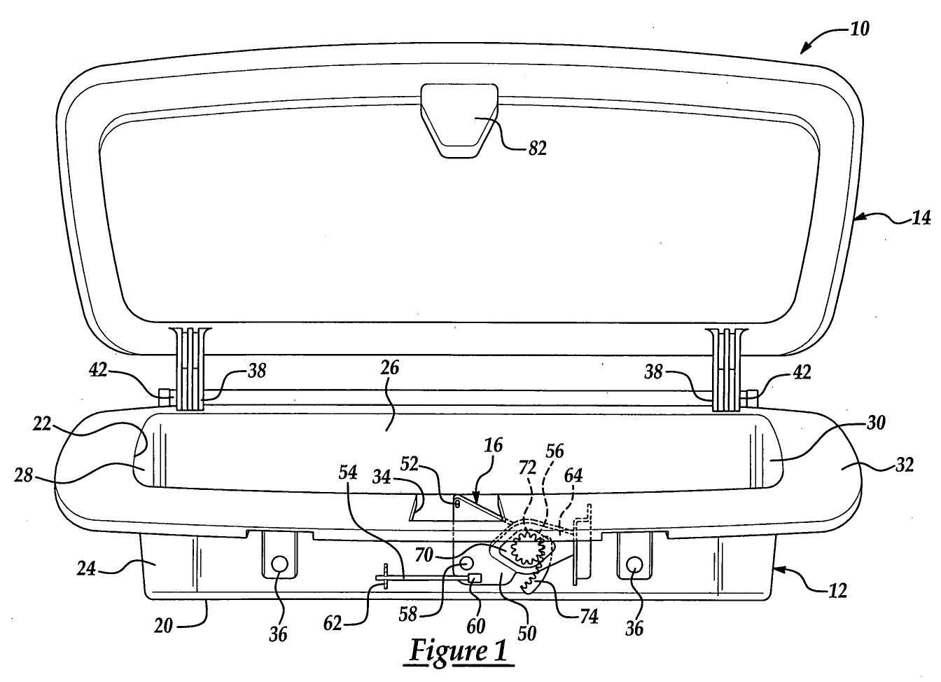

Referring to the drawings, an assembly having a latching mechanism is generally shown at 10 in FIG. 1. The assembly 10 is preferably adapted for installation in a vehicle and used for storage of items in a vehicle interior. Other types of assemblies, besides storage assemblies, are also contemplated including coin bins, ashtrays, cup holders, or any other type of assembly used in a vehicle where a latching mechanism 16 is desired.

The assembly 10 comprises a stationary first member 12, a moveable second member 14, and a latching mechanism 16. The first member 12 is preferably a storage compartment. The moveable second member 14 is preferably hinged to the first member 12 and acts as a door, lid, or cover to secure items within the first member 12. As shown, the latching mechanism 16 is mounted to the assembly 10 to the first member 12 for securing the second member 14 to the first member 12 when the assembly 10 is closed. It is contemplated, however, that the latching mechanism 16 could instead be adapted for mounting to the second member 14, involving a mere reversal of parts that would fall within the broad scope and spirit of the claims.

The first member 12 is preferably a compartment but may be a housing, frame, platform, or other structural support member for use with a glove box, coin bin, storage compartment, ashtray, cup holder, or the like for the interior of the vehicle. The compartment 12 is typically constructed of plastic, but other materials suitable for construction such as metal, wood, composites, and the like may be used. The compartment 12 may be used for storage in a vehicle dashboard, door, armrest, center console, headliner or any other area where storage is desired in the interior of the vehicle. The compartment 12 shown in FIG. 1 contains a base 20 and at least four walls that define an open section 22. The walls include a front wall 24, a back wall 26, a first side wall 28, and a second side wall 30. Preferably, the compartment 12 has a lip 32 that extends out from at least the front wall 24 at an end of the wall that defines the open section 22. The lip 32 allows the compartment 12 to easily install into the vehicle interior, and the lip 32 may also contain an aperture 34 near the front wall 24 to accommodate the latching mechanism 16. Additionally, the compartment 12 may contain bolt holes 36 to allow the assembly 10 to be bolted to the vehicle, such as in the dashboard or instrument panel. The compartment 12 also contains at least one hinge 38 on the back wall 26 for connecting the second member 14 to the compartment 12 to allow the second member 14 to act as a lid or door over the open section 22 of the compartment 12.

The second member 14 acts as a lid, such as a door, cover, or moveable member, for the assembly 10 and is slightly larger in area than the area of the open section 22 of the compartment 12. At least one biasing device 42, such as a spring, interfaces to the hinge 38 connecting the compartment 12 and lid 14. The spring 42 biases the lid 14 to an open position. A dampener (not shown) may be used in conjunction with the spring 42 to retard motion of the lid 14 when it opens and closes.

The latching mechanism 16 contains an actuator 50 to carry an engagement member 52 to engage the latch, a biasing device 54 to bias the actuator 50, and a dampener 56 to retard movement of the actuator 50. The latching mechanism 16 is preferably mounted externally on the compartment 12 to the front wall 24 below the aperture 34. Alternatively, the latching mechanism 16 could be mounted on the lid 14, such that the latching mechanism 16 is aligned with the front wall 24 when the assembly 10 is closed.

The actuator 50 is a pivotable arm that may be a variety of shapes for carrying the engagement member 52 into position for latching and unlatching. In the first embodiment, the actuator 50 is a planar oblong shaped member, as best shown in FIG. 1, and may be composed of plastic, metal, composites and the like. The actuator 50 is pivotably mounted on the compartment 12 preferably through a rivet 58 to allow rotation of the actuator 50. The biasing device 54 for biasing the actuator 50 to a home position is coupled to the actuator 50 by a socket 60 shown in FIG. 1. The biasing device 54 is preferably a spring steel rod or leaf spring and extends from the actuator 50 to a socket 62 on the front wall 24 of the compartment 12. However, other biasing devices, such as coiled torsional springs, may be adapted to rotatably bias the actuator 50. The biasing device 54 may extend in almost any direction from the actuator 50 or may be packaged neatly between the actuator 50 and compartment 12, thereby allowing the latching mechanism 16 to have a flexible and compact design.

The engagement member 52 extends from the actuator 50 near an end of the actuator closest to the lid 14 and the engagement member 52 extends generally perpendicular to the front wall 24. The engagement member 52 is preferably a rotatable follower, pin, rivet, or the like, but may be a fixed or integral element.

The actuator 50 preferably contains an extension 64 generally parallel to the front wall 24 for securing the dampener 56. The dampener 56 contains a top portion 70 secured to the extension 64 and a toothed member 72, or gear, rotatably attached to the top portion 70. The toothed member 72 engages a toothed member or rack 74 on the front wall 24. In one alternative arrangement, the dampener 56 could be fixably mounted to the front wall 24 and the extension 64 could have teeth for engaging the toothed member 72 of the dampener 56. In another alternative arrangement, the dampener 56 could be a barrel style dampener mounted to both the actuator 50 and to the front wall 24. As known in the art, the dampener 56 may contain a viscous fluid for retarding rotation of the toothed member 72 in relation to the top portion 70.

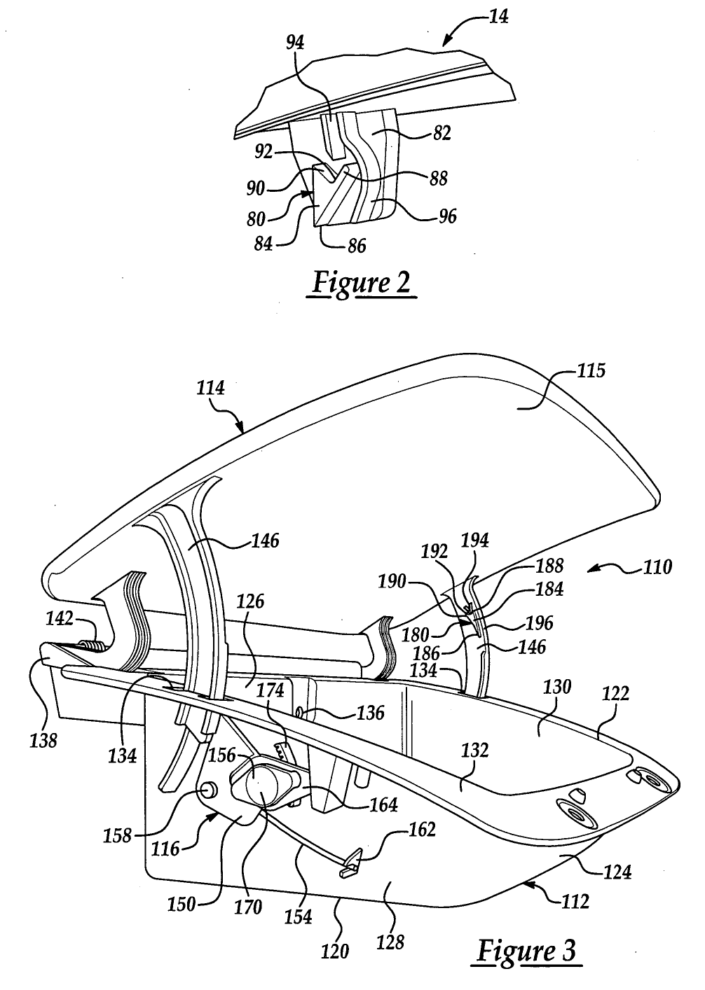

Referring to FIG. 2, a heart or labyrinth 80 is integrated into a tooth or projection 82 extending from the lid 14. Referring also to FIG. 1, the projection 82, is positioned such that the labyrinth 80 extends just outside the front wall 24 of the compartment 12 through the aperture 34, and is adjacent to the actuator 50 when the assembly 10 is closed wherein the engagement member 52 engages the labyrinth 80. As shown in FIG. 2, the labyrinth 80 contains a cam 84 having an apex 86, a first lobe 88, and a second lobe 90. The first and second lobes define a detent 92 positioned across from a deflector 94 of the labyrinth 80. In addition, a guide 96 is positioned along a side of the labyrinth 80.

The latching mechanism 16 operates in the following fashion. With the assembly 10 open, as shown in FIG. 1, the engagement member 52 is biased to a home position by the biasing device 54 and lines up with the labyrinth 80 just laterally inboard with respect to the second lobe 90 near the apex 86. As the door 14 is closed by the vehicle occupant, the engagement member 52 comes in contact with the labyrinth 80 between the cam 84 and the guide 96. As the lid 14 is closed further, the engagement member 52 runs along the cam 84, causing the actuator 50 to rotate on the front wall 24 against the biasing force of the biasing device 54. When the lid 14 is fully closed, the engagement member 52 clears the first lobe 88 allowing the biasing device 54 to force the actuator 50 to rotate towards the home position. The actuator 50 rotates until the engagement member 52 strikes the deflector 94, holding the engagement member 52 above the detent 92. Without the deflector 94, the actuator 50 would be allowed to rotate the engagement member 52 past the detent 92 and the assembly 10 would not latch. Once the lid 14 is released by the vehicle occupant, the hinge springs 42 biasing the lid 14 force the lid 14 to open slightly whereby the labyrinth 80 rises relative to the engagement member 52 thereby allowing the engagement member 52 to engage the detent 92 of the labyrinth 80 to lock the lid 14 in place and keep the assembly 10 closed and in a latched condition.

To release the latch, the vehicle occupant merely pushes the lid 14 further towards the compartment 12 against the bias force of the hinge springs 42. As the lid 14 is pushed from the latched position towards the compartment 12, the biasing device 54 rotates the actuator 50 toward the home position as the engagement member 52 follows the second lobe 90 out of the detent 92. When the vehicle occupant releases the lid 14, the hinge springs 42 biasing the lid 14 force the lid 14 to open. Because the engagement member 52 is outside of the detent 92, the engagement member 52 is able to completely pass through the labyrinth 80 and the lid 14 is able to fully retract to the open position as shown in FIG. 1.

The latching mechanism 16 also provides functionality to prevent the assembly 10 from accidentally opening when a sudden impact affects the assembly 10, such as due to a head impact with the assembly 10, or jolting of the vehicle due to a forward vehicle impact. The dampener 56 provides retardation of the latching mechanism 16 to avoid an accidental opening. The dampener 56 retards the actuator 50 from rotating the engagement member 52 outside of the detent 92 during a short duration impact, typically less than thirty milliseconds. The dampener 56 slows rotation of the actuator 50 by resisting rotation of the toothed member 72 in relation to the top portion 70. As the actuator 50 rotates, the top portion 70 moves with the actuator 50, causing the toothed portion to rotate along the rack 74. The dampener 56 resists the rotation of the toothed member 72 in relation to the top portion 70 and therefore, retards the rotation of the actuator 50. By retarding the actuator's rotation, the lid 14 is able to fully close and retract back to the latched position during an impact before the actuator 50 is able to rotate the engagement member 52 outside of the second lobe 90 and the detent 92. Therefore, the engagement member 52 remains in the detent 92 and prevents the lid 14 from opening when the lid 14 retracts after impact. The dampener 56 retards the engagement member from moving outside the second lobe 90 for a period of about ten milliseconds. Therefore, in order to open the assembly 10, the lid 14 must be held fully closed for slightly more than thirty milliseconds in order for the engagement member 52 to escape the detent 92 and release the latch for the lid 14 to open. If desired, the time period to release the latch could be adjusted by modifying the tension of the biasing device 54 and the resistance in the dampener 56.

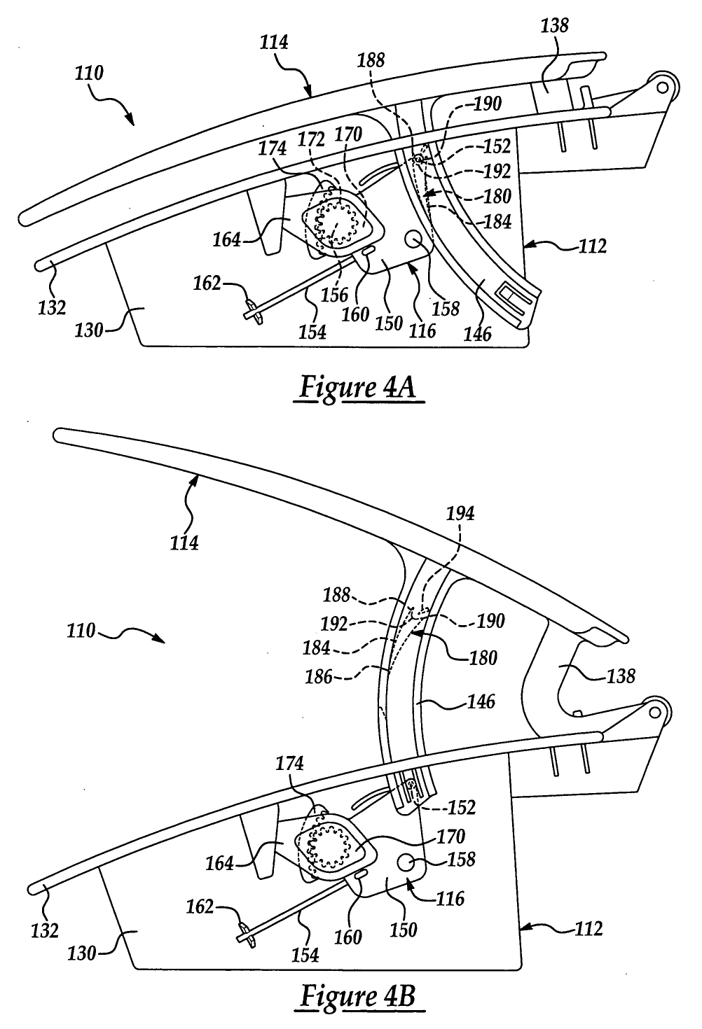

FIGS. 3 through 4B illustrate another presently preferred embodiment of a latching mechanism. This embodiment is similar in many respects to the embodiment of FIGS. 1 and 2, and like numerals between the embodiments generally designate like or corresponding elements throughout the several views of the drawing figures. Additionally, the description of the common subject matter will generally not be repeated here.

According to the embodiment shown in FIG. 3, an assembly 110 includes a compartment 112, a lid 114, and a latching mechanism 116 that is largely the same as that shown in FIG. 1. One difference is that the lid 114 includes two laterally opposed arms 146 extending down from a planar base 115, one arm 146 on each side of the base 115 as seen in FIG. 3. Laterally inboard vertical surfaces of the arms 146 each include a labyrinth 180 including a guide 196 and a cam 184 having a detent 192, a first lobe 188, and a second lobe 190, as best seen in FIGS. 4A and 4B. The arms 146 extend toward the compartment 112 with an arc similar to arc of the lid's rotation where the arms 146 meet the base 115 of the lid 114. The arms 146 extend through apertures in a lip 132 on the compartment 112 near two side walls 128, 130. In addition, latching mechanisms 116 are mounted to each side wall along with a rack 174. Each latching mechanism 116 is similar to the latching mechanism 116 in the previous embodiment and includes an actuator 150, a biasing device 154, an engagement member 152 and a dampener 156. Depending on the construction of the assembly 110, only one latching mechanism 116 may be red for this embodiment.

The latching operation is substantially similar to that previously described. FIG. 4A shows the assembly 110 open and the actuator 150 in a home position. The engagement member 152 does not line up with the labyrinth 180 because of the curve in the arm 146. As the door is closed by the vehicle occupant, the arm 146 swings through the aperture 134 in the lip 132 and allows the engagement member 152 to make contact with the labyrinth 180 between the cam 184 and the guide 196. As the lid 114 is closed further, the engagement member 152 runs along the cam 184, causing the actuator 150 to pivot on the compartment 112. As the actuator 150 rotates, the biasing device 154 resists the rotation. When the lid 114 is fully closed, the engagement member 152 clears the first lobe 188 allowing the biasing device 154 to force the actuator 150 to rotate towards the home position. The actuator 150 rotates until the engagement member 152 strikes the deflector 194, holding the engagement member 152 above the detent 192. As shown in FIG. 4B, once the lid 114 is released by the vehicle occupant, the springs 142 biasing the lid 114 force the lid 114 to open slightly until the engagement member 152 locks the lid 114 into place by engaging the detent 192 of the labyrinth 180, thereby keeping the assembly 110 closed and in a latched position.

To release the latch, the vehicle occupant merely has to push the lid 114 further towards the compartment 112. As the lid 114 is pushed from the latched position towards the compartment 112, the biasing device 154 rotates the actuator 150 toward the home position as the engagement member 152 follows along the second lobe 190 until the engagement member 152 is out of the detent 192. When the vehicle occupant releases the lid 114, the springs 142 biasing the lid 114 force the lid 114 to open. Since the engagement member 152 is outside of the detent 192 the engagement member 152 is able to completely pass through the labyrinth 180 and the lid 114 is able to fully retract to the open position as shown in FIG. 4A.

As in the previous embodiment, the latching mechanism 116 prevents the assembly 110 from opening due to a head impact or jolt to the vehicle. The dampener 156 retards the actuator 150 from rotating the engagement member 152 outside of the detent 192 during a short duration impact. The dampener 156 slows rotation of the actuator 150 by resisting rotation of the top portion 172 in relation to the top portion 170. As the actuator 150 rotates, the top portion 170 moves with the actuator 150 and causes the toothed member 172 to rotate along the rack 174. During an impact, the lid 114 is able to fully close and retract back to the latched position before the actuator 150 is able to rotate the engagement member 152 outside of the second lobe 190 and the detent 192. Therefore, the engagement member 152 catches the detent 192 and prevents the lid 114 from opening when the lid 114 retracts after impact.

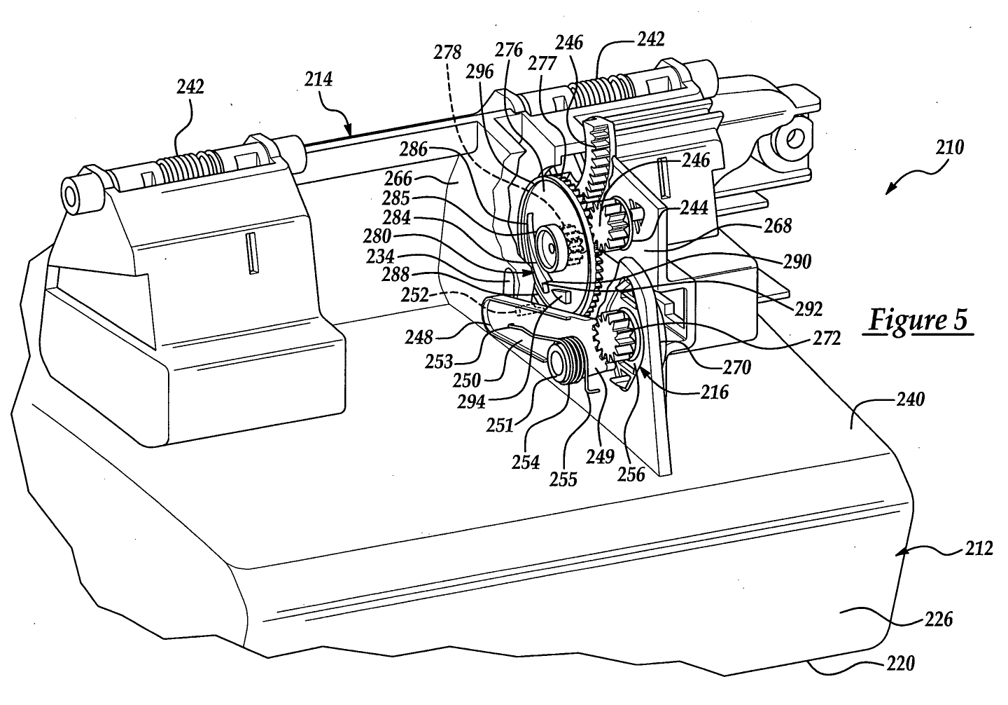

FIG. 5 illustrates another presently preferred embodiment of a latching mechanism. This embodiment is similar in many respects to the embodiments of FIGS. 1 through 4B and like numerals between the embodiments generally designate like or corresponding elements throughout the several views of the drawing figures. Additionally, the description of the common subject matter will generally not be repeated here.

According to the embodiment shown in FIG. 5, an assembly 210 includes a compartment 212, a lid 214, and a latching mechanism 216. The compartment 212 contains side walls, a base 220 and a top 240. The top 240 contains a first support 266 and a second support 268 generally parallel with each other extending off the top 240.

The compartment 212 also contains members for hinging the lid 214 to the compartment 212, wherein the lid 214 is hinged to the compartment 212 to allow the assembly 210 to open and close. Hinge springs 242 bias the lid 214 to an open position. A toothed arm 246 extends from the lid 214 between the first and second supports 266, 268 on the compartment 212. The toothed arm 246 rotates as the lid 214 opens and closes, and is arced to match the radius of the rotation.

A combination gear 276 having a smaller toothed gear 278 and a larger toothed gear 277 is rotatably carried by the compartment 212 between the first and second supports 266, 268. The smaller gear 278 engages the toothed arm 246 such that the combination gear 276 rotates when the lid 214 is opened and closed. The larger gear 277 engages a dampener 244 mounted on the second support 268 to retard movement of the lid 214 when the springs open the lid 214. The dampener 244 is similar to the dampeners previously disclosed and contains a toothed member 246 engaged with the larger gear 277. The combination gear 276 also includes a labyrinth 280 between the larger gear 277 and the first support 266. The labyrinth 280 is substantially similar to the labyrinths previously disclosed and is ultimately carried by the compartment 212 via the gear 276. The labyrinth 280 contains a cam 284 having a detent 292, an apex 286, a first lobe 288, a second lobe 290, a deflector 294 across from the detent 292, and a guide 296.

The latching mechanism 216 contains several components including an actuator 250 to carry an engagement member 252 to engage the labyrinth 280, a biasing device 254 to bias the actuator 250, and a dampener 256 to retard movement of the actuator 250. The actuator 250 is rotatably mounted to the first support 266 of the compartment 212 to allow the actuator 250 to rotate about an axis generally perpendicular with a plane generally established by the first support 266. A spool 251 extends from the actuator 250 and away from the first support 266 to carry the biasing device 254. The actuator 250 extends from a first end 248 to a toothed second end 249. The toothed second end 249 has teeth to engage a toothed member 272 of the dampener 256 having a top portion 270 mounted to the first support 266. Alternatively, the dampener 256 could be mounted to the actuator 250 and the toothed member 272 could engage a rack 274 carried by the first support 266, similar to the arrangement of FIG. 1.

The engagement member 252 extends off the actuator 250 near the first end 248 and extends through an aperture 234 in the first support 266 between the actuator 250 and the labyrinth 280. Although shown broken away, the engagement member 252 terminates in an end (not shown) that is engageable with the detent 292 of the labyrinth 280.

The biasing device 254 coils around the spool 251 on the actuator 250. The biasing device 254 is a preferably coiled torsional spring having a first arm 253 inserted into the actuator 250 near the first end 248, and a second arm 255 inserted into the first support 266 near the second end 249 of the actuator 250. Moreover, the biasing device 254 biases the first end 248 of the actuator 250 toward the first support 266 in a lateral direction to keep the engagement member 252 extended through the aperture 234 in the first support 266. The biasing device 254 also biases the actuator 250 to a biasing point along the actuator's axis of rotation to assist the engagement member 252 in engaging the detent 292.

The latching mechanism 216 operates in the following fashion. With the assembly 210 open, the combination gear 276 is rotated such that the engagement member 252 lines up with the labyrinth 280 just beyond the second lobe 290 near the apex 286 of the cam 284. As the vehicle occupant closes the lid 214, the toothed arm 246 rotates the combination gear 276 clockwise causing the engagement member 252 to eventually run along the cam 284 between the cam 284 and the guide 296. As the engagement member 252 runs along the cam 284 the actuator 250 rotates on the first support 266 as the biasing device 254 resists the rotation. When the lid 214 is fully closed, the engagement member 252 clears the first lobe 288 of the cam 284, thereby allowing the biasing device 254 to force the actuator 250 to rotate towards the home position. The actuator 250 rotates until the engagement member 252 strikes the deflector 294, holding the engagement member 252 above the detent 292. Without the deflector 294, the actuator 250 would be allowed to rotate the engagement member 252 outside the detent 292 and the assembly 210 would not latch. Once the lid 214 is released by the vehicle occupant, the springs 242 biasing the lid 214 force the lid 214 to open slightly causing the toothed member 246 to rotate the combination gear 276 slightly counterclockwise. Then, under the rotational bias force imposed on the actuator 250 by the biasing device 254, the engagement member 252 moves into engagement with the detent 292 of the labyrinth 280, thereby keeping the assembly 210 closed and in a latched position.

To release the latch, the vehicle occupant merely has to push the lid 214 further towards the compartment 212. As the lid 214 is pushed from the latched position towards the compartment 212, the toothed arm 246 rotates the combination gear 276 slightly in the clockwise direction. The biasing device 254 rotates the actuator 250 toward the home position as the engagement member 252 follows the second lobe 290 out of the detent 292. When the vehicle occupant releases the lid 214, the springs 242 biasing the lid 214 force the lid 214 to open. As the lid 214 opens, the toothed arm 246 causes the combination gear 276 to rotate counterclockwise. By this time, the engagement member 252 has come out of the detent 292, has passed the lobe 290, and then passes between the cam 284 and a hub 285 of the labyrinth 280 as the combination gear 276 rotates, and the lid 214 is thus able to fully retract to the open position.

As in the previous embodiments, the latching mechanism 216 prevents the assembly 210 from opening due to a head impact or jolt to the vehicle. The dampener 256 retards the actuator 250 from rotating the engagement member 252 outside of the detent 292 during a short duration impact. The dampener 256 slows rotation of the actuator 250 by resisting rotation of the toothed member 272 in relation to the top portion 270. As the actuator 250 rotates, the toothed member 272 rotates in relation to the top portion 270 causing the viscous fluid in the dampener 256 to resist the rotation. During an impact, the lid 214 is able to fully close and retract back to the latched position before the actuator 250 is able to rotate the engagement member 252 outside of the second lobe 290 and the detent 292. Therefore, with the aid of the dampener 256, the engagement member 252 remains engaged in the detent 292 and prevents the lid 214 from opening when the lid 214 retracts after impact.

The latching mechanism 216 can also be used in conjunction with other devices for the interior of a vehicle such as adjustable cup holders, ash trays, light assemblies, or any other devices where a push-push style latch is desirable.

It is to be understood that the foregoing description is not a description of the invention, but is a description of one or more presently preferred embodiments of the invention. Accordingly, the invention is not limited to the particular exemplary embodiments disclosed herein, but rather is defined solely by the claims below. In other words, the statements contained in the foregoing description relate to particular exemplary embodiments and are not to be construed as limitations on the scope of the invention as claimed below or on the definition of terms used in the claims, except where a term or phrase is expressly defined above or where the statement specifically refers to “the invention.” Various other embodiments and various changes and modifications to the disclosed embodiments will become apparent to those skilled in the art. All such other embodiments, changes, and modifications are intended to come within the scope of the appended claims.

As used in this specification and claims, the phrases “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components, elements, or items. Moreover, directional words such as top, bottom, upper, lower, radial, circumferential, axial, lateral, longitudinal, vertical, horizontal, and the like are employed by way of description and not limitation. Other terms are to be construed using their broadest reasonable meaning unless they are used in a context that requires a different interpretation. When introducing elements of the present invention or the embodiments thereof, the articles “a,” “an,” “the,” and “the” are intended to mean that there are one or more of the elements.

The present invention has been disclosed in conjunction with a limited number of presently preferred exemplary embodiments, but many others are possible and it is not intended herein to mention all of the possible equivalent forms and ramifications of the present invention. Other modifications, variations, forms, or ramifications will readily suggest themselves to persons of ordinary skill in the art in view of the foregoing description, and will fall within the scope of the following claims. In other words, the teachings of the present invention encompass many reasonable substitutions or equivalents of limitations recited in the following claims. For example, the disclosed structure, materials, sizes, shapes, and the like could be readily modified or substituted with other similar structure, materials, sizes, shapes, and the like. Indeed, the present invention is intended to embrace all forms, ramifications, modifications, variations, substitutions, and/or equivalents as fall within the spirit and broad scope of the following claims.

1. A latching mechanism adapted for use with an assembly having a first member and a moveable second member, one of the first and second members carries a labyrinth having a detent and further wherein the other of the first and second members carries the latching mechanism, the latching mechanism comprising:
an actuator pivotably mounted on the other of the first and second members, the actuator carrying an engagement member wherein the engagement member is disposed within the detent when the assembly is closed;
a biasing device coupled to the actuator for biasing the actuator;
at least one of the actuator and the other of the first and second members including a first toothed member; and
a dampener coupled to the actuator and including a second toothed member adapted for engagement with the first toothed member thereby coupling the dampener to the other of the first and second members for retarding movement of the actuator, wherein upon a sudden impact affecting the assembly when closed, the dampener retards movement of the actuator for a predetermined time to enable the engagement member to remain disposed in the detent to keep the assembly closed.

2. The latching mechanism as defined in claim 1, wherein the moveable second member carries the labyrinth, the actuator is mounted on a front external surface of the first member, the first toothed member is a toothed rack of the first member, and the dampener is fixed to the actuator.

3. The latching mechanism as defined in claim 1, wherein the moveable second member carries the labyrinth, the actuator is mounted on a side external surface of the first member, the first toothed member is a toothed rack of the first member, and the dampener is fixed to the actuator.

4. The latching mechanism as defined in claim 1, wherein the first member carries a combination gear carrying the labyrinth, the actuator is mounted to the first member, the actuator carries the first toothed member at one end thereof, and the dampener is fixed to the first member and the second toothed member of the dampener is coupled to the first toothed member.

5. A vehicle interior assembly comprising:
a stationary member carrying a labyrinth-carrying element having a labyrinth with a detent;
a movable member movably mounted to the stationary member and including a toothed arm in engagement with said labyrinth carrying element;
a latching mechanism carried by the stationary member and including:
an actuator pivotably mounted on the stationary member and carrying an engagement member, wherein the engagement member is disposed within the detent of the labyrinth when the assembly is closed;
a biasing device coupled to the actuator for biasing the actuator; and
a dampener coupled to the actuator, wherein upon a sudden impact affecting the assembly when closed, the dampener retards movement of the actuator for a predetermined time to enable the engagement member to remain disposed in the detent to keep the assembly closed.

6. The vehicle interior assembly as defined in claim 5, wherein the dampener of the latching mechanism further includes a toothed member, and the actuator contains teeth engaged with the toothed member of the dampener.

7. The vehicle interior assembly as defined in claim 5, wherein the dampener is a viscous fluid gear type of dampener.

8. The vehicle interior assembly as defined in claim 5, wherein the engagement member extends from the actuator through the stationary member.

9. The vehicle interior assembly as defined in claim 5, wherein the biasing device is a coil spring attached to the actuator at a first end and attached to the stationary member at a second end and wherein the biasing device biases the actuator toward the stationary member.

10. The vehicle interior assembly as defined in claim 5, wherein the labyrinth carrying element contains teeth.

11. The vehicle interior assembly as defined in claim 10, wherein the moveable member contains teeth engaged with the labyrinth carrying element and wherein moving the moveable member from an open position to a closed position rotates the labyrinth carrying element.

12. The vehicle interior assembly as defined in claim 11, wherein rotation of the labyrinth carrying member allows the engagement member to enter the detent of the labyrinth when the moveable member is in the closed position and allows the engagement member to exit the detent of the labyrinth when the moveable member is in the open position.

13. The vehicle interior assembly as defined in claim 5, whereby a sudden impact upon the moveable member will not result in the moveable member moving to the open position.

14. A vehicle interior assembly comprising:
a stationary member including a latching mechanism coupled thereto and a toothed member;
a moveable member movably coupled to the stationary member and including a labyrinth having a detent;
the latching mechanism including:
an actuator pivotably mounted on the stationary member;
an engagement member carried on the actuator for engaging the detent of the labyrinth when the assembly is closed;
a biasing device coupled to the actuator and to the stationary member; and
a dampener mounted on the actuator and having a toothed member engaging the toothed member of the stationary member, wherein upon a sudden impact affecting the assembly when closed, the dampener retards movement of the actuator for a predetermined time to enable the engagement member to remain disposed in the detent to keep the assembly closed.

15. The latching mechanism as defined in claim 14, whereby the biasing device is a leaf spring.

16. The latching mechanism as defined in claim 14, whereby the latching mechanism is mounted on an external surface of the assembly.

17. The latching mechanism as defined in claim 14, whereby the moveable member is hinged to the stationary member and biased to an open position through a biasing device.

18. The latching mechanism as defined in claim 14, whereby movement of the moveable member is dampened by a dampener.

19. The latching mechanism as defined in claim 14, whereby the moveable member is hinged to the assembly on a rear side of the assembly opposite a front side, and the latching mechanism is mounted on the front side of the assembly.

20. The latching mechanism as defined in claim 14, whereby the moveable member contains an arm carrying the labyrinth.
